(19) United States
(12) Patent Application Publication
(10) Pub. No.: US 2025/0296239 A1
(43) Pub. Date: Sep. 25, 2025

(54) Systems, Computer Program Products, and Methods for Controlling Robots

(71) Applicant: Sanctuary Cognitive Systems Corporation, Vancouver (CA)

(72) Inventor: Suzanne Gildert, Vancouver (CA)

(21) Appl. No.: 18/991,645

(22) Filed: Dec. 22, 2024

Related U.S. Application Data
(60) Provisional application No. 63/614,138, filed on Dec. 22, 2023.

(51) Int. Cl. B25J 9/16; B25J 13/06

(52) U.S. Cl. CPC B25J 9/1697; B25J 9/1689; B25J 13/06

(57) ABSTRACT

Provided herein is a control system and methods thereof for controlling operation of a robot. The control system comprises: a robot, including a plurality of sensors wherein each generating a stream of raw sensor data having a data type, size, and frequency, and a plurality of actuators cause movement of the robot; an autonomous control subsystem configured to receive the sensor data and output autonomous actuator data; and a teleoperation control subsystem configured to receive the sensor data, transmit the sensor data to a human operator, and output teleoperation actuator control signals, wherein the autonomous control subsystem and the teleoperation control subsystem receive, from the robot, sensor data having the same data type, size, and frequency, and wherein the autonomous actuator data and the teleoperation actuator data have the same data type, size, and frequency; and a control-determining subsystem configured to switch between autonomous and teleoperation control.

### TECHNICAL FIELD

The present systems, computer program products, and methods generally relate to controlling operation of said systems and computer program products, and particularly relate to multi-purpose robots that are capable of at least semi-autonomously completing multiple different work objectives.

### DESCRIPTION OF THE RELATED ART

Robots are machines that may be deployed to perform work. Robots may come in a variety of different form factors, including humanoid form factors. Humanoid robots may be operated by teleoperation systems through which the robot is caused to emulate the physical actions of a human operator or pilot; however, such teleoperation systems typically require very elaborate and complicated interfaces comprising sophisticated sensors and equipment worn by or otherwise directed towards the pilot, thus requiring that the pilot devote their full attention to the teleoperation of the robot and limiting the overall accessibility of the technology.

Robots may be trained or otherwise programmed to operate semi-autonomously or fully autonomously. Training a robot typically involves causing the robot to repeatedly perform a physical task in the real world, which can cause significant wear and tear on the components of the robot before the robot can even be deployed to perform useful work in the field. Additionally, the costs and materials associated with training physical robots, especially when the robot is controlled by an elaborate teleoperation system, may be prohibitive when the success of a physical robot for a given task cannot be guaranteed.

Therefore, there is a need in the field for systems and methods which provide improved control and training of robots to avoid the above issues.

### BRIEF SUMMARY

Provided herein is a control system for controlling operation of a robot in an environment, the control system comprising: a robot, including a plurality of sensors configured to convert information from the environment and the robot into sensor data, wherein each sensor of the plurality of sensors generates a stream of raw sensor data having a data type, a size, and a frequency, and a plurality of actuators configured to cause movement of the robot; an autonomous control subsystem, communicatively coupled to the robot, and configured to receive the sensor data from the plurality of sensors and output autonomous actuator data to the plurality of actuators; and a teleoperation control subsystem, communicatively coupled to the robot, and configured to receive the sensor data from plurality of sensors, transmit the sensor data to a human operator, and output teleoperation actuator control signals to the plurality of actuators, wherein the teleoperation actuator data are generated according to input from the human operator, wherein the autonomous control subsystem and the teleoperation control subsystem receive, from the robot, sensor data having the same data type, the same size, and the same frequency, and wherein the autonomous actuator data and the teleoperation actuator data have the same data type, the same size, and the same frequency; and a control-determining subsystem configured to determine which of the autonomous control subsystem and the teleoperation control subsystem may control the robot.

The robot may be interchangeable between a physical robot in a physical environment and a simulated robot in a simulated environment, wherein the plurality of sensors of the physical robot comprise a plurality of physical sensors generating physical sensor data from the physical environment, and the plurality of actuators of the physical robot comprises a plurality of physical actuators receiving physical actuator data; the plurality of sensors of the simulated robot comprises a plurality of simulated sensors generating simulated sensor data from the simulated environment, and the plurality of actuators of the simulated robot comprises a plurality of simulated actuators receiving simulated actuator data, wherein each simulated sensor is analogous to a respective physical sensor wherein the simulated sensor data is approximately the same as the respective physical sensor data, and each simulated actuator is analogous to a respective physical actuator wherein the simulated actuator data is approximately the same as the respective physical actuator data.

The autonomous control subsystem may control the robot with fully autonomous control, wherein artificial intelligence determines the autonomous actuator data.

The autonomous control subsystem may control the robot with semi-autonomous control, wherein a human operator determines the autonomous actuator data.

The autonomous control subsystem may include a graphical user interface to display the sensor data for viewing by the human operator and an input device for receiving instructions from the human operator.

The autonomous control subsystem may include a feature extraction module which is configured to receive at least one sensor data stream from the robot and convert the at least one sensor data stream to features, wherein features are semantically meaningful information.

The features may include at least one of: location of detected objects, orientation of detected objects, labels of detected objects, mapping of the environment, text extracted from speech, text extracted from visual feed, facial recognition labels, presence of hand in the scene, joint states for actuators of the robot, and faces in a field of view.

The feature extraction module may include a plurality of specialized submodules to each extract a feature from the at least one sensor data stream.

The control system may further comprise an attention module which is configured to turn on and off at least one of the specialized submodules.

The autonomous control subsystem may continuously generate a robot-perceived model of the environment of the robot based on the features extracted from the robot sensor data by the feature extraction module, wherein the data type, data size, and data frequency of the sensor data and the actuator data are the same for a physical environment, a simulated environment, and the robot-egocentric model.

The autonomous control subsystem may test actuator data within the robot-egocentric model to determine the effects of an actuator data driven action before sending the actuator data to the robot.

The autonomous control subsystem may include a concrete state representation updater which provides data about the current state of the remote environment as understood by the autonomous control subsystem.

The teleoperation system may be a low-level teleoperation (LLT) system including hardware for transmitting sensor data from the robot to the human operator as sensory information and hardware for tracking the motion of the human operator.

The hardware may include haptic gloves, an exoskeleton configured to use encoder measurements and forward kinematics to determine a position and an orientation of the limbs of the human operator, motors within the joints to provide force feedback to the human operator, a headset for providing visual and auditory information about the robot and the remote environment to the human operator, and/or bidirectional pedals to control a mobile base of the robot.

The sensor data may include at least one of audio sensor data, joint position data, pressure data, force sensitive resistor data, mobile base wheel encoder data, inertial measurement unit data, and visual data.

The actuator data may include at least one of audio data, joint position data, impedance data, and mobile base motion data.

Also provided herein is a method of controlling a robot, the method comprising selecting, by a control-determining subsystem, which one of an autonomous control subsystem and a teleoperation control subsystem may control the robot, wherein the robot comprises a plurality of sensors configured to convert information from an environment and the robot into sensor data, wherein each sensor of the plurality of sensors generates a stream of raw sensor data having a data type, a size, and a frequency, and a plurality of actuators configured to cause movement of the robot, and when the autonomous control subsystem is selected receiving, by the autonomous control subsystem, the sensor data from the plurality of sensors, generating, by the autonomous control subsystem, autonomous actuator data based on the sensor data, and outputting autonomous actuator data to the plurality of actuators of the robot; and when the teleoperation control subsystem is selected receiving, by the teleoperation control subsystem, the sensor data from plurality of sensors, transmitting, by the teleoperation control subsystem, the sensor data to a human operator, generating, by the teleoperation control subsystem, teleoperation actuator data based on the sensor data, and outputting, by the teleoperation control subsystem teleoperation actuator control signals to the plurality of actuators, wherein the teleoperation actuator data are generated according to input from the human operator; and wherein the autonomous control subsystem and the teleoperation control subsystem receive, from the robot, sensor data having the same data type, the same size, and the same frequency for each of the plurality of sensors, and wherein the autonomous actuator data and the teleoperation actuator data have the same data type, the same size, and the same frequency for each of the plurality of actuators.

The robot may be interchangeable between a physical robot in a physical environment and a simulated robot in a simulated environment wherein the plurality of sensors of the physical robot comprise a plurality of physical sensors generating physical sensor data from the physical environment, and the plurality of actuators of the physical robot comprises a plurality of physical actuators receiving physical actuator data, the plurality of sensors of the simulated robot comprises a plurality of simulated sensors generating simulated sensor data from the simulated environment, and the plurality of actuators of the simulated robot comprises a plurality of simulated actuators receiving simulated actuator data; wherein each simulated sensor is analogous to a respective physical sensor wherein the simulated sensor data is approximately the same as the respective physical sensor data, and each simulated actuator is analogous to a respective physical actuator wherein the simulated actuator data is approximately the same as the respective physical actuator data.

The autonomous control subsystem may control the robot with fully autonomous control, wherein artificial intelligence determines the autonomous actuator data.

The autonomous control subsystem may control the robot with semi-autonomous control, wherein a human operator determines the autonomous actuator data.

The autonomous control subsystem may include a graphical user interface and an input device, and the method may further comprise displaying the sensor data on the graphical user interface for viewing by the human operator, and receiving instructions through the input device from the human operator.

The autonomous control subsystem may include a feature extraction module and the method may further comprise receiving at least one sensor data stream of the sensor data from the robot by the feature extraction module, and converting the at least one sensor data stream to features, wherein features are semantically meaningful information.

The features may include at least one of: location of detected objects, orientation of detected objects, labels of detected objects, mapping of the environment, text extracted from speech, text extracted from visual feed, facial recognition labels, presence of hand in the scene, joint states for actuators of the robot, and faces in a field of view.

The feature extraction module may comprise a plurality of specialized submodules and the method may further comprise extracting a feature from the at least one sensor data stream by at least one specialized submodule.

The autonomous control subsystem may further comprise an attention module and the method may further comprise setting an on or off status at least one of the specialized submodules by the attention module.

The method may further comprise generating, by the autonomous control subsystem, a robot-perceived model of the environment of the robot based on the features extracted from the robot sensor data by the feature extraction module, wherein the data type, data size, and data frequency of the sensor data and the actuator data are the same for a physical environment, a simulated environment, and the robot-egocentric model.

The method may further comprise testing, by the autonomous control subsystem, actuator data within the robot-egocentric model to determine the effects of an actuator data driven action before sending the actuator data to the robot.

The autonomous control subsystem may include a concrete state representation updater and the method may further comprise providing data about the current state of the remote environment, as understood by the autonomous control subsystem, by the concrete state representation updater.

The teleoperation system may be a low-level teleoperation (LLT) system including hardware for transmitting sensor data from the robot to the human operator as sensory information and hardware for tracking the motion of the human operator.

The sensor data may include at least one of audio sensor data, joint position data, pressure data, force sensitive resistor data, mobile base wheel encoder data, inertial measurement unit data, and visual data.

The actuator data may include at least one of audio data, joint position data, impedance data, and mobile base motion data.

Also provided herein is a control system for interchangeably controlling operation of a physical robot and a simulated robot analogous to the physical robot, the system comprising the physical robot, including a plurality of sensors configured to convert information from a physical environment and information from the physical robot into physical sensor data, wherein each sensor of the plurality of sensors generates a stream of raw sensor data having a data type, a size, and a frequency, and a plurality of physical actuators configured to cause movement of the physical robot; the simulated robot, including a plurality of simulated sensors configured to convert information from a simulated environment and information from the simulated robot into sensor data, and a plurality of simulated actuators configured to cause movement of the simulated robot; wherein each simulated sensor is analogous to a respective physical sensor wherein the simulated sensor data is approximately the same as the respective physical sensor data, each simulated actuator is analogous to a respective physical actuator wherein the simulated actuator data is approximately the same as the respective physical actuator data, the physical sensor data and the simulated sensor data have the same data type, the same size, and the same frequency; and a control subsystem, communicatively coupled to the physical robot and the simulated robot, and configured to receive the physical sensor data from the plurality of physical sensors and output actuator data to the plurality of physical actuators, and configured to receive the simulated sensor data from the plurality of simulated sensors and output simulated actuator data to the plurality of simulated actuators, wherein the physical actuator data and the simulated actuator data have a same data type, a same size, and a same frequency.

The control subsystem may be an autonomous control subsystem.

The control subsystem may be a teleoperation control subsystem.

Other aspects and features will become apparent, to those ordinarily skilled in the art, upon review of the following description of some exemplary embodiments.

### BRIEF DESCRIPTION OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is a block diagram of a robot control system comprising a robot, a control-determining subsystem, an autonomous control subsystem, and a teleoperation subsystem as described throughout the present systems, methods, and computer program products.

FIG. 2 is a block diagram showing a control system for a physical robot in accordance with the present systems, methods, and computer program products.

FIG. 3 is a block diagram showing a control system for a simulated robot in accordance with the present systems, methods, and computer program products.

FIG. 4 is a block diagram showing examples of sensor data which are sent to a control system and converted to actuator data.

FIG. 5A is a picture of a physical environment with a physical robot in accordance with the present systems, method, and computer program products.

FIG. 5B is a picture of a simulated environment with a simulated robot in accordance with the present systems, method, and computer program products.

FIG. 6 is a block diagram showing an autonomous control system for a simulated robot including a robot-perceived environment in accordance with the present robots, methods, and computer program products.

FIG. 7 is a block diagram showing an autonomous control system for a physical robot including a robot-perceived environment in accordance with the present robots, methods, and computer program products.

FIG. 8A is a picture of an outer world (OW) model of a simulated robot in accordance with the present systems, method, and computer program products.

FIG. 8B is a picture showing feature extraction of the OW model of FIG. 8A in accordance with the present systems, method, and computer program products.

FIG. 8C is an inner world (IW) model of the OW model of FIG. 8A in accordance with the present systems, method, and computer program products.

FIG. 9 is a flow diagram of a method of controlling a robot, in accordance with the present systems, methods and computer program products.

FIG. 10 is an example of a graphical user interface for semi-autonomous control by an autonomous control system.

### DETAILED DESCRIPTION

The following description sets forth specific details in order to illustrate and provide an understanding of the various implementations and embodiments of the present systems, computer program products, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present robots, computer program products, and methods.

A general-purpose robot is able to complete multiple different work objectives. As used throughout this specification and the appended claims, the term “work objective” refers to a particular task, job, assignment, or application that has a specified goal and a determinable outcome, often (though not necessarily) in the furtherance of some economically valuable work. Work objectives exist in many aspects of business, research and development, commercial endeavors, and personal activities. Exemplary work objectives include, without limitation: cleaning a location (e.g., a bathroom) or an object (e.g., a bathroom mirror), preparing a meal, loading/unloading a storage container (e.g., a truck), taking inventory, collecting one or more sample(s), making one or more measurement(s), building or assembling an object, destroying or disassembling an object, delivering an item, harvesting objects and/or data, and so on. The various implementations described herein provide robots, computer program products, and methods for initializing, configuring, training, operating, and/or deploying a robot to at least semi-autonomously complete multiple different work objectives.

A robot may be operative to perform any number of high-level functions based at least in part on its hardware and software configurations. For example, a robot with legs or wheels may be operative to move, a robot with a gripper may be operative to pick things up, and a robot with legs and a gripper may be operative to displace objects. The performance of any such high-level function generally requires the controlled execution of multiple low-level functions. For example, a mobile robot must exercise control of a number of different lower-level functions in order to controllably move, including control of mobility actuators (e.g., driving its legs or wheels) that govern functional parameters like speed, trajectory, balance, and so on.

As discussed above, training a robot has typically involved causing the robot to repeatedly perform a physical task in the real world, which can cause significant wear and tear on the components of the robot before the robot can even be deployed to perform useful work in the field. Additionally, the costs and materials associated with physical robots may be prohibitive when the success of a physical robot for a given task cannot be guaranteed. Building a physical robot is a time-consuming, expensive process compared to generating a simulated instance of a robot. The repetitions of a task that can be accomplished by a simulated robot are on a scale of hundreds, thousands, or even millions compared to a physical robot. That is, when teaching a physical robot to pick up a cup an attempt can be made once in a given period of time, while in the same period of time N simulated robots (where N could be tens, hundreds, thousands, or millions) could attempt to pick up the cup N times, depending on the computing resources. Each N instance of the simulated robot may be identical in parameters and environment to a real physical robot and to each other N simulated robot, or some of the N instances may have slight differences to optimize the process. The actuation of each simulated robot may be accelerated so that more tests can be accomplished more quickly compared to a physical robot.

Herein, systems, computer program products, and methods for controlling operation of a robot are provided.

Herein “robot” generally refers to a robot which emulates or mimics human anatomy. However, this is not necessarily the case, and any appropriate form of robot could be used. In some implementations, a robot may only partially emulate human anatomy (e.g. the robot may only include a limited subset of human-like features), or a robot may not emulate human anatomy at all.

In general, throughout this specification and the appended claims, a method of controlling the operation of a robot is a method in which at least some of the various acts are performed by a control system and some of the various acts are performed by the robot. Certain acts of a method of controlling the operation of a robot may be performed by at least one processor or processing unit communicatively coupled to at least one non-transitory processor-readable storage medium. In some implementations, certain acts of a method of controlling the operation of a robot may be performed by peripheral components of the robot that are communicatively coupled to the at least one processor, such as one or more physically actuatable components (e.g., arms, legs, end effectors, grippers, hands), one or more sensors (e.g., optical sensors, audio sensors, tactile sensors, haptic sensors), mobility systems (e.g., wheels, legs), communications and networking hardware (e.g., receivers, transmitters, transceivers), and so on. The at least one non-transitory processor-readable storage medium may store data and/or processor-executable instructions that, when executed by the at least one processor, cause the control system and the robot to perform the method and/or cause the at least one processor to perform those acts of the method that are performed by the at least one processor. Unless the specific context requires otherwise, references to a non-transitory processor-readable storage medium, as well as data and/or processor-executable instructions stored in a non-transitory processor-readable storage medium, are not intended to be limiting as to the physical location of the non-transitory processor-readable storage medium in relation to the at least one processor and the rest of the control system and robot hardware. In other words, A non-transitory processor-readable storage medium may include non-transitory processor-readable storage media located on-board the robot and/or non-transitory processor-readable storage media located remotely from the robot, unless the specific context requires otherwise. Further, a method of operation of a robot can be implemented as a computer program product. Such a computer program product comprises processor-executable instructions or data that, when the computer program product is stored on a non-transitory processor-readable storage medium of the robot, and the computer program product is executed by at least one processor of the robot, the computer program product (or the processor-executable instructions or data thereof) cause the robot to perform acts of the method.

Training a robot for a future job or task may be completed with a physical robot in a physical environment or a simulated robot in a simulated environment. Control of a robot may be achieved by an autonomous control system or an analogous teleoperation control system, wherein autonomous control uses a cognitive architecture to autonomously control the robot without physical input from another party (e.g., wherein an artificial intelligence determines actuation of the robot) and analogous teleoperation analogously controls the robot using physical input from another party, such as a human operator or “pilot”.

In some embodiments, autonomous control is fully-autonomous wherein an artificial intelligence determines all actions of the robot. In other embodiments, the autonomous control is semi-autonomous control wherein a graphical user interface displays robot data and options regarding possible tasks and actuations for a human operator, wherein the human operator, instead of an artificial intelligence, chooses tasks and therefore actuations through the graphical user interface.

Analogous teleoperation control may also be referred to as “low-level teleoperation”.

Herein, it is to be understood that “autonomous control” may refer to either fully-autonomous or semi-autonomous control (where applicable). Generally herein, autonomous control is discussed with reference to an artificial intelligence autonomously controlling a robot, but it is to be understood that, where applicable, for a scenario discussing autonomous control, an embodiment employing semi-autonomous control is also included.

Therefore, when training a robot there are four possible scenarios: i) autonomous control of a physical robot, ii) teleoperation control of a physical robot, iii) autonomous control of a simulated robot, and iv) teleoperation control of a simulated robot.

The use of a simulated robot in a simulated environment is intended to replicate a physical robot in a physical environment such that control or training of the simulated robot can be taught or achieved without requiring a physical robot. For example, a pilot could learn to teleoperatively control a simulated robot instead of learning to control a physical robot, thus eliminating risks to a physical robot. In another example, a user wishing to determine if a robot can accomplish an intended task can use a simulated robot in a simulated environment to train and analyze the simulated robot for the task without the need to acquire the physical robot. In yet another example, a user may want to train a robot to be able to perform a task through teleoperation control but also want the robot to be able to perform the task autonomously. In order to achieve these goals, regardless of whether the robot is a physical robot or a simulated robot, and of whether the control is autonomous or teleoperation, the operation of the robot must be as uniform between all four scenarios as is possible. To ensure this uniformity, the data which passes from any type of robot to any type of control and vice versa must be at least approximately identical. That is, from the robot side, the robot cannot identify which type of control system is sending actuation instructions, i.e., autonomous vs. teleoperation, and from the control side, environmental information sent from a simulated robot cannot be distinguished from environmental information sent from a physical robot by the control system, including any human operators of a teleoperation control system.

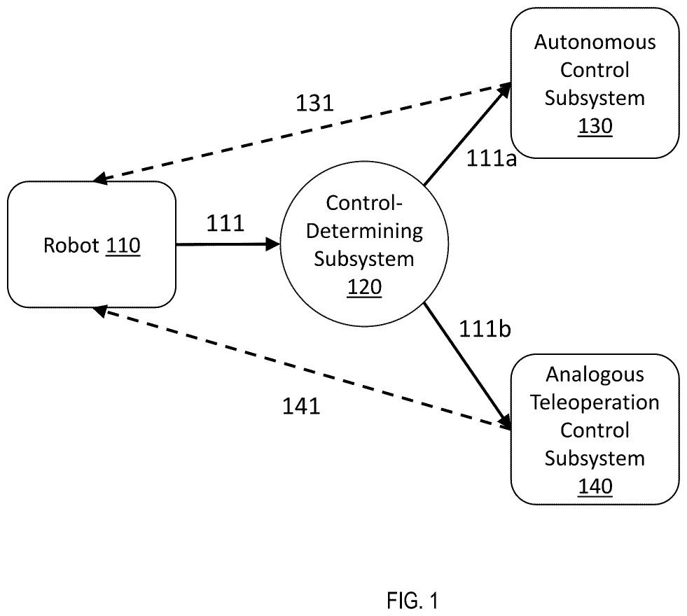

FIG. 1 is a block diagram of a robot control system 100 comprising a robot 110, a control-determining subsystem 120, an autonomous control subsystem 130, and a teleoperation subsystem 140 as described throughout the present systems, methods, and computer program products.

Autonomous control subsystem 130 enables autonomous control (fully- or semi-autonomous) of robot 110. Teleoperation subsystem 140 enables a human operator to analogously control robot 110 (e.g., low-level teleoperation).

Robot control system 100 is shown at a high level. It is to be understood that each of robot 110, control-determining subsystem 120, autonomous control subsystem 130, and teleoperation control subsystem 140 include other components.

Robot 110 is communicatively coupled to control-determining subsystem 120, autonomous control subsystem 130, and teleoperation control subsystem 140.

Control-determining subsystem 120 is communicatively coupled to autonomous control subsystem 130 and teleoperation control subsystem 140.

Robot 110 exists within an environment. Robot 110 may be a physical robot in a physical environment or a simulated robot in a simulated environment.

Robot 110 includes a plurality of sensors which convert information from the environment and the robot into sensor data 111. Robot 110 includes a plurality of actuators which control movement of the robot.

Control-determining subsystem 120 determines which one of autonomous control subsystem 130 and teleoperation subsystem 140 controls the operation of the robot. That is, the control-determining subsystem 130 determines which of the two control subsystems receives the sensor data from the robot.

Although sensor data 111 is shown in FIG. 1 as passing through control-determining subsystem 120, this is meant only to convey that control-determining subsystem 120 determines the direction of sensor data 111 and not that the sensor data is received by control-determining subsystem 120 and then sent from control-determining subsystem 120. In some implementations, the control-determining subsystem 120 may receive sensor data 111, while in other implementations the sensor data 111 may be sent directly to one of the control subsystems.

Control-determining subsystem 120 may take on any form which allows for choosing which one of the control subsystems 130 and 140 control operation of robot 110. For example, control-determining subsystem 120 may be represented within software wherein a user checks a box on a graphical user interface to choose which control subsystem is operational.

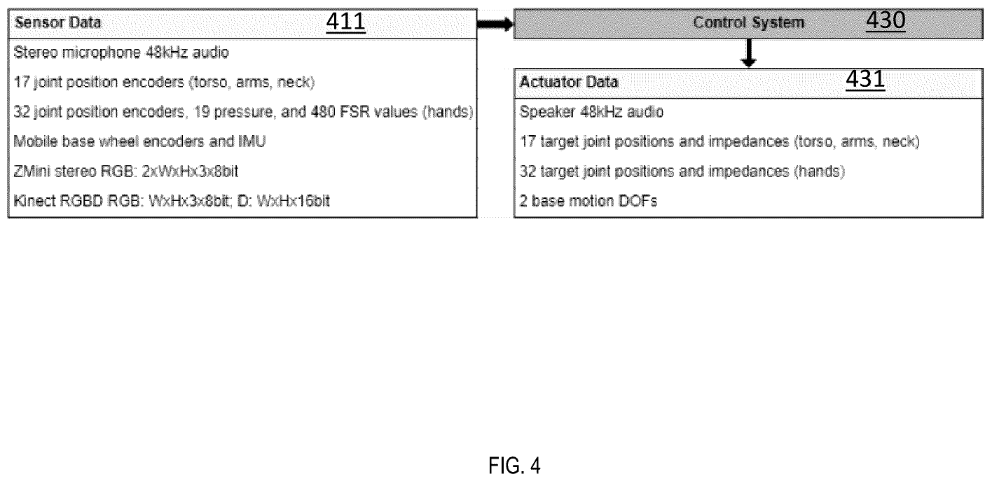

Regardless of which one of autonomous control subsystem 130 and/or teleoperation control subsystem 140 receives sensor data 111, the control subsystem converts a specific list of sensor data into a specific list of actuation data. Exemplary sensor data and actuation data are shown and described in FIG. 4.

In FIG. 1, when the control of robot 110 is set to autonomous control subsystem 130 by control-determining subsystem 120, sensor data 111 is sent to autonomous control 130 subsystem, as represented by arrow 111a.

Autonomous control subsystem 130 sends actuator data 131 to robot 110 to cause robot 110 to perform a task. When autonomous control subsystem 130 is fully autonomous, autonomous control subsystem 130 and robot 110 perform tasks without input from another party (e.g., a pilot). In other embodiments, where the autonomous control subsystem is semi-autonomous there may be limited input from a human operator.

In other embodiments, the autonomous control system 130 may act as a semi-autonomous control system wherein a graphical user interface allows a human user to choose the tasks and actuation of robot 110. That is, the autonomous control system may determine which tasks are possible based on the sensor data input from robot 110 and a human user may view the possible tasks on a graphical user interface and choose which, when, and in what order tasks are performed.

In FIG. 1, when the control of robot 110 is set to teleoperation control subsystem 140 by control-determining subsystem 120, sensor data 111 is sent to teleoperation control subsystem 140, as represented by arrow 111b.

Teleoperation control subsystem 140 sends actuator data 141 to robot 110 to cause robot 110 to perform a task. Teleoperation control subsystem 140 causes robot 110 to perform tasks based on input from another party (e.g., a human operator). The type of input from the human operator may differ depending on the level of teleoperation involved. Analogous teleoperation involves the use of a hardware system, or “pilot rig hardware”, which is designed to relay sensory signals coming from a remote humanoid robot to a person, called a pilot, and convert the person's movement (including speech) into actuator data 141 sent to robot 110.

For low-level teleoperation it is required that a target humanoid robot analogously follows the movements of the human operator or “pilot”. For this to be possible, the motion of the human operator must be tracked and the hardware must facilitate the transmission of sensory information to the human operator from the remote environment.

Briefly, the pilot rig hardware of a low-level teleoperation control subsystem may include:
i) haptic gloves responsible for tracking the motion of the human operator's fingers. These gloves may also provide force feedback through skin deformation.
ii) a pilot rig comprising an exoskeleton designed specifically for our teleoperation setup. It uses encoder measurements, along with the forward kinematics of the device, to determine the position and orientation of the pilot's limbs. The rig has motors within its joints, allowing the device to provide force feedback to the pilot.
iii) a VR headset to provide visual and audio feedback to the pilot. The headset is the pilot's primary channel of information regarding the robot and its surrounding environment.
iv) bidirectional pedals which allow the pilot to control a mobile base of the robot.

Returning now to control system 100, sensor data 111 is sent to one of the control subsystems as a raw sensor data stream comprising sensor data packets. The sensor data packets have a data type, e.g., audio data, visual data, digital data, etc., a size, and a frequency at which the packets are sent. In order to maintain the same experience and level of control from both autonomous control subsystem 130 and teleoperation subsystem 140, sensor data 111a and 111b are identical, with a and b denoting only where the sensor data 111 is sent and not any difference in the sensor data 111.

Actuator data 131 and actuator data 141, are sent to robot 110 to control the movement of robot 110, as an actuator data stream having a data type, a size, and a frequency. The data type is the same for actuator data 131 and actuator data 141. The size and frequency of actuator data 131 and actuator data 141 are at least approximately identical for the same actuation of the robot. That is, the size and frequency of actuator data 131 and actuator data 141 are within a chosen small tolerance, e.g., +/−10%.

To summarize, the data generated and output by robot 110 and the data being received by the robot from a control system (130 or 140) is identical or approximately identical regardless of the control subsystem which is currently in control.

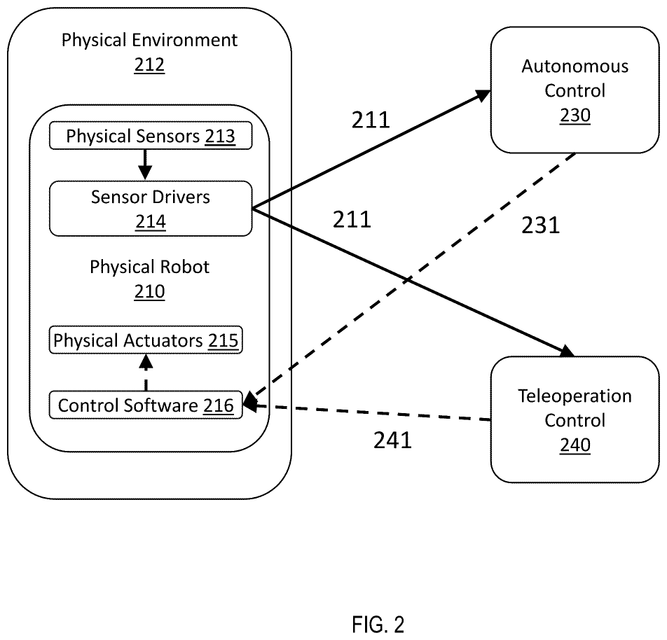

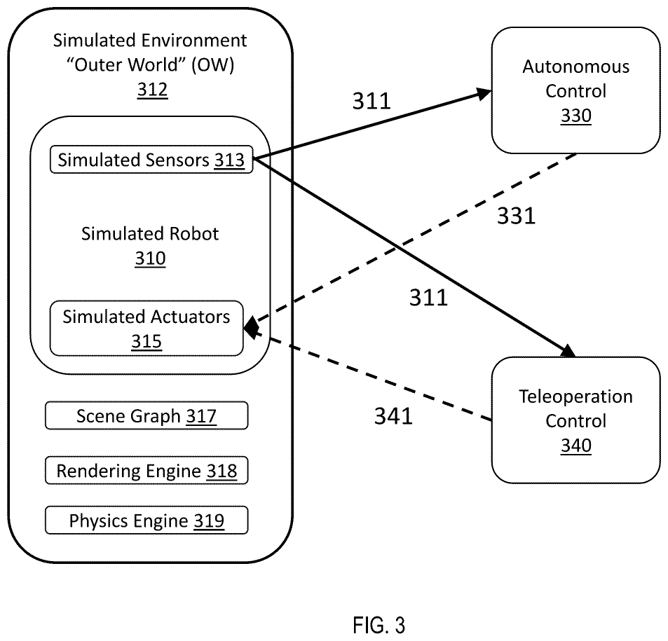

As mentioned above, robot 110 may be a physical robot in a physical environment or a simulated robot in a simulated environment. FIG. 2 shows a physical robot and FIG. 3 shows a simulated robot.

Broadly, in embodiments with both a physical robot and a simulated robot, a control system architecture is similar to that described above for FIG. 1, and enables interchangeable control between the operation of a physical robot and a simulated robot analogous to the physical robot.

The physical robot includes a plurality of sensors configured to convert information from a physical environment and information from the physical robot into physical sensor data. Each sensor of the plurality of sensors generates a stream of raw sensor data having a data type, a size, and a transmission frequency. The physical robot includes a plurality of physical actuators configured to cause movement of the physical robot.

The simulated robot includes a plurality of simulated sensors configured to convert information from a simulated environment and information from the simulated robot into simulated sensor data. Each simulated sensor is analogous to a respective physical sensor of the physical robot wherein the simulated sensor data is approximately the same as the respective physical sensor data including the same data type, data size, and data transmission frequency. A plurality of simulated actuators are configured to cause movement of the simulated robot and each simulated actuator is analogous to a respective physical actuator.

A control subsystem, which may include an autonomous control subsystem, an analogous control subsystem, or both subsystems, is communicatively coupled to both the physical robot and the simulated robot, and configured to receive the physical sensor data from the plurality of physical sensors and output actuator data to the plurality of physical actuators, and also configured to receive the simulated sensor data from the plurality of simulated sensors and output simulated actuator data to the plurality of simulated actuators, wherein the physical actuator data and the simulated actuator data have a same data type, a same size, and a same transmission frequency.

The control subsystem may include a control-determining subsystem or control determining module which enables an autonomous control system or a human operator to switch which robot is being controlled. The control-determining subsystem may be a software program which enables an artificial intelligence or a human operator to choose between the physical robot and the simulated robot. In some embodiments, the control-determining subsystem which allows for switching between control of a physical robot and a simulated robot may be the same subsystem which enables switching between autonomous control and analogous control (e.g., the same software). In other embodiments, the control-determining subsystem which allows for switching between control of a physical robot and a simulated robot may be different from the subsystem which enables switching between autonomous control and analogous control.

FIG. 2 is a block diagram showing a control system 200 for a physical robot 210 in accordance with the present systems, methods, and computer program products. Control system 200 includes physical robot 210, an autonomous control subsystem 230, and a teleoperation control subsystem 240. Not shown, to reduce clutter, is a control-determining subsystem for determining which of autonomous control subsystem 230 and teleoperation control subsystem 240 control the operation of physical robot 210.

Physical robot 210 exists within a physical environment 212.

Physical robot 210 comprises a plurality of physical sensors 213 which generate data from physical environment 212 by sending sensor signals to a plurality of sensor drivers 214. The sensor drivers 214 send a raw sensor data stream to one of autonomous control subsystem 230 and teleoperation control subsystem 240 as sensor data 211.

Physical robot 210 also comprises a plurality of physical actuators 215 which are controlled by a control software 216. The control software receives actuator data from one of autonomous control subsystem 230 (actuator data 231) and teleoperation control subsystem 240 (actuator data 241).

In FIG. 2, when the control of physical robot 210 is set to autonomous control subsystem 230, sensor data 211 is sent to autonomous control 230 subsystem.

Autonomous control subsystem 230 sends actuator data 231 to physical robot 210 to cause physical robot 210 to move, e.g., to perform a task. In a fully autonomous control subsystem, scenario, together autonomous control subsystem 230 and physical robot 210 perform tasks without input from another party (e.g., a pilot). In an embodiment where the autonomous control subsystem is semi-autonomous, there may be limited input from a human operator.

In FIG. 2, when the control of physical robot 210 is set to teleoperation control subsystem 240, sensor data 211 is sent to teleoperation control subsystem 240.

Teleoperation control subsystem 240 sends actuator data 241 to physical robot 210 to cause robot 210 to perform a task. Teleoperation control subsystem 240 causes physical robot 210 to perform tasks based on input from another party (e.g., a human operator). The type of input from the human operator may differ depending on the level of teleoperation involved. Analogous teleoperation, or “low-level teleoperation” involves the use of a hardware system which is designed to relay sensory signals coming from a remote humanoid robot to a person, called a pilot, and convert the person's movement (including speech) into actuator data 241 sent to physical robot 210.

In either control scenario, autonomous control or teleoperation control, control software 216 is configured to receive actuator data 231/241 and instruct actuators 215 to move physical robot 210 to perform tasks.

As described above for FIG. 1, a raw sensor data stream of sensor data 211 is identical in data type, size, and frequency regardless of the control subsystem 230 or 240, which is receiving sensor data 211.

As described above, an actuator data stream of actuator data 231 or 241 are at least approximately identical in data type, size, and frequency.

FIG. 3 is a block diagram showing a control system 300 for a simulated robot 310 in accordance with the present systems, methods, and computer program products.

Control system 300 includes simulated robot 310, an autonomous control subsystem 330, and a teleoperation control subsystem 340. Not shown, to reduce clutter, is a control-determining subsystem for determining which one of autonomous control subsystem 330 and teleoperation control subsystem 340 control the operation of simulated robot 310.

Simulated robot 310 “exists” within a simulated environment 312 or “outer world” (OW) model. The simulated environment is a pre-constructed simulation environment, similar to, for example, a video game world or other sim world. An OW model may be an analogous recreation of a real-world environment but does not need to be. The simulated environment simulates the physics and relative scale of objects in the real-world to enable accurate robot operation. Of note, there is no connection between an OW model of simulated robot 310 and a physical robot operating in real-time. However, simulated robot 310 needs to operate analogously to a physical robot to ensure that a physical robot, controlled by either an autonomous control subsystem or a teleoperation control system, would operate in a physical environment in the same way simulated robot 310 operates within simulated environment 312, when controlled by either autonomous control subsystem 330 or teleoperation control subsystem 340. To that end, simulated robot 310 may be modelled after a real-world robot counterpart or at least real world sensors and actuators.

The OW model is generated based on a scene graph 317, by a rendering engine 318, and a physics engine 319. Scene graph 317 is a data structure providing a logical and spatial representation of a graphical scene. \ Rendering engine 318 is software which continuously generates the model using the graphical scene. Physics engine 319 is software which ensures that the physical aspects of the model (e.g., gravity) are correct.

Simulated robot 310 comprises a plurality of simulated sensors 313 which generate data from simulated environment 312. Simulated sensors 313 send a raw sensor data stream to one of autonomous control subsystem 330 and teleoperation control subsystem 340 as sensor data 311. Each of the simulated sensors 313 is analogous to a respective physical sensor of a real-world physical robot counterpart of simulated robot 310.

Simulated robot 310 also comprises a plurality of simulated actuators 315. The simulated actuators 315 receive actuator data from one of autonomous control subsystem 330 (actuator data 331) and teleoperation control subsystem 340 (actuator data 341). Each of the simulated actuators 315 is analogous to a respective physical actuator of a real-world physical robot counterpart of simulated robot 310.

In FIG. 3, when the control of simulated robot 310 is set to autonomous control subsystem 330, sensor data 311 is sent to autonomous control subsystem 330.

Autonomous control subsystem 330 sends actuator data 331 to simulated actuators 315 to cause simulated robot 310 to move, e.g, to perform at least one work task. In a fully autonomous control scenario, autonomous control subsystem 330 and simulated robot 310 perform work tasks without input from another party (e.g., a pilot), when to perform the individual tasks and the order of how those tasks are carried out is determined by the autonomous control subsystem 330 with the sensor data input from simulated robot 310. In other embodiments, where the control is semi-autonomous, there may be limited input from a human operator.

In FIG. 3, when the control of simulated robot 310 is set to teleoperation control subsystem 340, sensor data 311 is sent to teleoperation control subsystem 340.

Teleoperation control subsystem 340 sends actuator data 341 to simulated actuators 315 to cause simulated robot 310 to perform at least one work task. Teleoperation control subsystem 340 causes simulated robot 310 to perform work tasks based on input from another party (e.g., a human operator). The type of input from the human operator may differ depending on the level of teleoperation involved. For example, analogous teleoperation, or “low-level teleoperation” involves the use of a hardware system which is designed to relay sensory signals coming from a remote humanoid robot to a person, called a pilot, and convert the person's movement (including speech) into actuator data 341 sent to simulated robot 310.

As described above for FIG. 1, a raw sensor data stream of sensor data 311 is identical in data type, size, and frequency regardless of the control subsystem 330 or 340, which is receiving sensor data 311. Additionally, the data type, size, and frequency of the raw sensor data stream of sensor data 311 is approximately identical to sensor data which would be generated by a “real-world” physical robot counterpart (e.g., 211 from FIG. 2).

As described above, actuator data 331 or 341 (i.e., a data stream of actuator data) are at least approximately identical in data type, size, and frequency.

FIG. 4 is block diagram showing examples of sensor data 411 which are received by a control system 430 and actuator data 431 which may be generated based on the sensor data 411.

The sensor data includes:
i) stereo microphone 48 kHz audio
ii) 17 joint position encoders (including torso, arms, neck, etc.)
iii) 32 joint position encoders, 19 pressure values, and 480 FSR values (hands)
iv) mobile base wheel encoders and IMU
v) ZMini steror RGB: 2×W×H×3×8 bit
vi) Kinect RGB: W×H×3×8 bit, D: W×H×16 bit

The actuator data includes:
i) speaker 48 kHz audio
ii) 17 target joint position and impedances (torso, arms, neck)
iii) 32 target joint positions and impedances (hands)
iv) 2 base motion degree of freedom (DOFs)

Table 1, below, shows additional types of sensor data which could be captured for a physical robot or a simulated robot. The size and frequency of the data packets of the data stream of the sensor data is also shown. As described above, the size and frequency of the sensor data packets (or the actuation data packets) are identical or nearly identical regardless of whether the robot is a simulated robot or physical robot or whether the control system is an autonomous control system (fully- or semi-autonomous) or a teleoperation control system. As described above, the simulated robot is generated to match a real (existing or not yet existing) physical robot and therefore the sensor data types and formats are the same (identical or so close as to be identical) between the simulated robot and the real physical robot it represents.

TABLE 1
Sensor Data Type/Format

Joint states (position, velocity, torque)/2 kB@1 kHz
Haptic feedback (fingers)/1 kB@200 Hz
Link health and critical telemetry/1 kB@100 Hz
Commands (position, velocity torque)/2 kB@1 kHz
Hand poses and configurations/1 kB@200 Hz
Localization and mapping/100 B@100 Hz
Depth camera/5 mB@30 Hz
Stereo camera/10 mB@90 Hz
Microphones/50 kB@90 Hz
Speakers/1 kB@50 Hz
Environment motion (mobile base and legs)/100 B@100 Hz
Logs/10 GB@1 h
System status/10 kB@1 Hz
Management/1 kB@0.1 Hz
Unit configuration/1 kB@0.1 Hz or 100 mMB@1 d
Mode of operation/100 B@0.5 Hz
Upper torso trajectory/1 kB@0.5 Hz < 10 samples
Touch State/1 kB@100 Hz < 10 samples
Warning and alarms/100 kB@10 Hz < 100 samples
Acknowledge and bypass/10 kB@1 Hz < 10 samples
Motion configuration requests/1 kB@1 Hz < 10 samples
Upper torso motion requests/1 kB@010 Hz < 100 samples

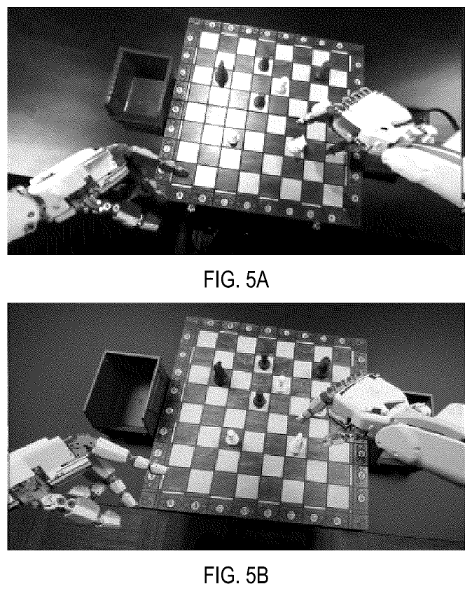

FIG. 5A is a picture of a physical environment with a physical robot in accordance with the present systems, method, and computer program products. FIG. 5A shows a physical robot playing a game of chess.

FIG. 5B is a picture of a simulated environment with a simulated robot in accordance with the present systems, method, and computer program products. FIG. 5B shows a simulated robot playing a game of chess.

It can be seen that many elements within the environment of FIG. 5A are the same as FIG. 5B, e.g., the positions of the table, chess board, chess pieces, robot arms, robot hands, robot fingers, the blue receptacles. However, some elements of FIG. 5A are not the same as FIG. 5B, e.g., the light reflecting on the chess board and the table in FIG. 5A is not present in FIG. 5B and the lack of light on the fingers of the left hand of the robot in FIG. 5A is not conveyed in FIG. 5B. Additionally, the clarity of the numbers and letters on the board is better in the simulated environment of FIG. 5B and the texture of the chess squares is different between the two figures.

The simulated environment of FIG. 5B not only matches the appearance of FIG. 5A, but invisible physical properties, such as gravitational constant, mass of objects, surface hardness/conformity, etc. are designed to match those of the real environment of FIG. 5A.

In FIGS. 5A and 5B, the robots may be controlled by either an autonomous control subsystem or a teleoperation control subsystem. The teleoperation control subsystem may be a low-level teleoperation control subsystem comprising hardware which allows analogous control of the robot by a pilot.

FIG. 5A represents a real-world physical environment while FIG. 5B represents the OW model of the simulated environment of the simulated robot. However, neither of these images represent what the robot perceives the environment to be.

A representation of the robot's perception of its environment (be it physical or simulated) is generated as an “inner world” (IW) model or “robot-perceived environment”. The robot-perceived environment may have all of the same parts as an OW model (i.e., a pre-constructed environment) or physical environment. The IW model is a robot-egocentric model which the robot creates for the robot's own environment.

The IW model is analogous to a human mind's understanding or construction of the external environment. For example, when a human enters a room the understanding of the room within the human mind is based on what is perceived and there are unknowns about the room until the mind can collect more data (e.g., what is behind the human can be determined by turning around).

To that end, the IW model is fundamental to how a robot operates under autonomous control. Reasoning, planning, deduction, and learning are all based on the IW model. For an autonomous control system, all control is executed based on the inner world model regardless of whether the system is controlling a real-world robot in the real-world or a simulated robot in a simulated world. That is, when controlling a real-world robot in the real world, the autonomous control system creates an inner world model in real-time and all robot actuation is rooted in this IW model. Likewise when controlling a simulated robot in a simulated OW model, the autonomous control system creates an IW model of the OW model and all robot actuation is rooted in this IW model.

Cognitive scientists are largely united in the view that human cognition is object-centric. Therefore, the models discussed herein focus on objects (including the robot's own body and its parts), relationships between objects, and object-focused temporal events (such as collisions between objects). Because of this, in both OW and IW models environments are built out of the composition of objects (including object-focused temporal events).

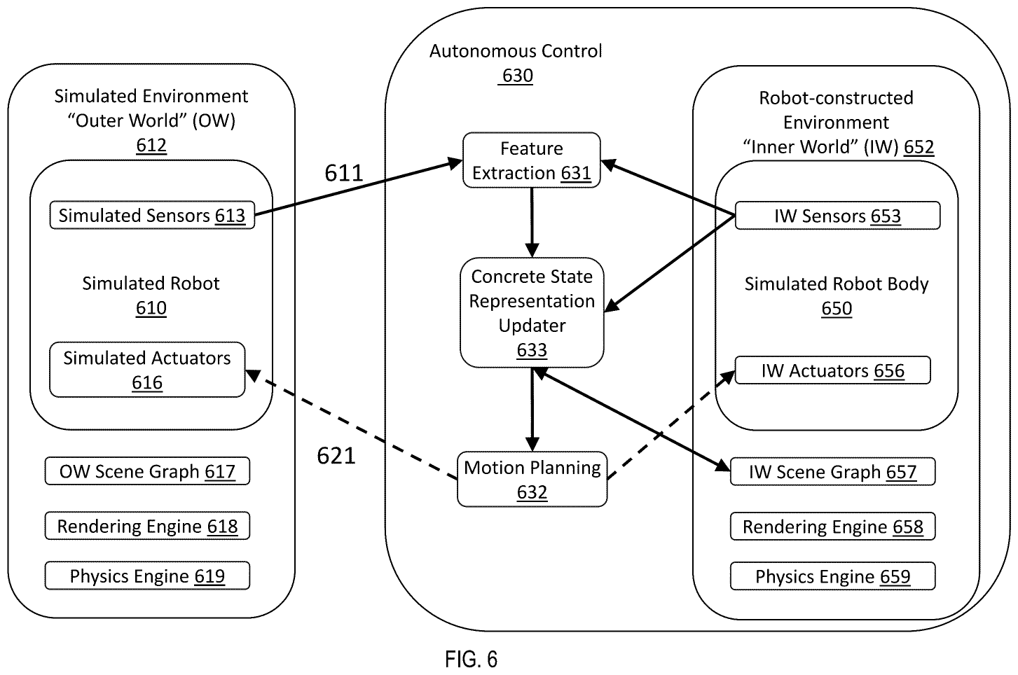

When the robot-perceived environment is created for a simulated robot, the IW model may use the exact same machinery as the OW model simulation, and includes a model of the robot's body from the perspective of the robot. The IW model is dynamically generated by a cognitive architecture of the autonomous control subsystem. This is shown in FIG. 6.

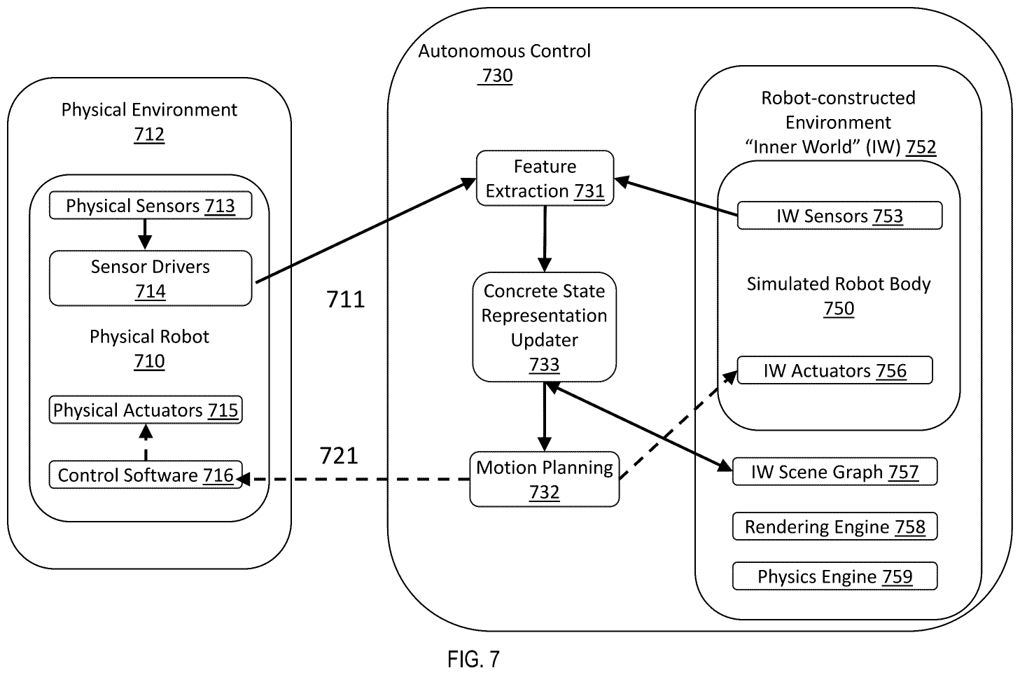

When the robot-perceived environment is created for a physical robot, the IW model may use the same machine as is used to generate an OW model simulation, and also includes a model of the physical robot's body from the perspective of the robot. The IW model is dynamically generated by the cognitive architecture of the autonomous control system. This is shown in FIG. 7.

While the OW model is used for both autonomous control and analogous teleoperation control of a simulated robot, the IW model is employed only for autonomous control of either a simulated robot or a physical robot. That is, there is no IW model employed in analogous teleoperation of a robot.

FIG. 6 is a block diagram showing an autonomous control system 630 for a simulated robot 610 including a robot-perceived environment 652 in accordance with the present robots, methods, and computer program products.

Simulated robot 610 may be similar or identical to simulated robot 310 of FIG. 3.

Simulated robot 610 “exists” within a simulated environment 612 or “outer world” (OW) model. The simulated environment is a pre-constructed simulation environment, similar to, for example, a video game world or other sim world. An OW model may be an analogous recreation of a real-world environment but does not need to be. The simulated environment simulates the physics and relative scale of objects in the real-world to enable accurate robot operation. Of note, there is no connection between an OW model of simulated robot 610 and a physical robot operating in real-time. However, simulated robot 610 needs to operate analogously to a physical robot to ensure that a physical robot, controlled by either an autonomous control subsystem or a teleoperation control system, would operate in a physical environment in the same way simulated robot 610 operates within simulated environment 612, when controlled by autonomous control subsystem 630. To that end, simulated robot 610 may be modelled after a real-world robot counterpart or at least real world sensors and actuators.

The OW model is generated by a scene graph 617, a rendering engine 618, and a physics engine 619.

Simulated robot 610 comprises a plurality of simulated sensors 613 which generate data (e.g., simulated sensor data) from simulated environment 612. Simulated sensors 613 send a raw simulated sensor data stream 611 to autonomous control subsystem 630. Each of the simulated sensors 613 is analogous to a respective physical sensor of a real-world physical robot counterpart of simulated robot 610.

Simulated robot 610 comprises a plurality of simulated actuators 615. The simulated actuators 615 receive actuator data (e.g., simulated actuator data) from autonomous control subsystem 630 (simulated actuator data 631). Each of the simulated actuators 615 is analogous to a respective physical actuator of a real-world physical robot counterpart of simulated robot 610.

Autonomous control system 630 is a computing device system including at least one processor and at least one memory. In embodiments where autonomous control is semi-autonomous, the system also includes at least one graphical user interface device (e.g., display or monitor) to display a graphical user interface for a human operator and at least one input device (e.g., keyboard, mouse, and/or touchscreen) to receive input from the human operator.

Autonomous control system 630 includes a feature extraction module 631, a motion planning submodule 632, and concrete state representation updater (Concrete SRU) module 633. Autonomous control system 630 receives raw simulated sensor data stream 611 from simulated sensors 613 and generates a “robot-perceived environment” or “inner world” (IW) model 652. IW model 652 is a robot-egocentric model of the OW of the simulated robot 610 which includes a simulated robot body 650 comprising a model of the body of the robot as perceived by the robot, inner world sensors 653, and inner world actuators 656. The inner world sensors 653 are simulated sensors which are analogous to the simulated sensors 613. The inner world actuators 656 are simulated actuators which are analogous to the simulated actuators 616. The IW model 652 is generated by an IW scene graph 657, a rendering engine 658, and a physics engine 659.

Because the raw simulated sensor data stream 611 only represents what the simulated robot 610 has perceived about the OW environment 612, the information used to generate the IW model 652 is incomplete compared to the actual OW environment 612. There is more information within the OW 612 than the simulated robot 610 can perceive. Not only is the information perceived by the simulated robot 610 limited compared to the actual OW information available but the information may actually be wrong. For example, a simulated robot may perceive an apple as a ball. Generating the IW model 652 allows the autonomous control system 630 to imagine what the effects of action-taking would be inside if the IW model 652 of the OW 612 before having to commit to actually taking those actions in the OW 612. This machinery allows autonomous control system 630 to ‘think about the world’, and predict what will happen in the future, as well as to learn from mistakes and make corrections. For example, if the robot has perceived an apple to be a ball resulting in an interaction with the apple not going as anticipated, the apple can be better characterized going forward.

Autonomous control system 630 uses feature extraction module 621 to generate the IW model 652.

Feature extraction module 621 takes low-level, sub-symbolic, high bandwidth, complex sensory data streams, including raw video, audio, proprioceptive and haptic streams, and converts them into high-level, symbolic, semantically meaningful information called features. Feature extraction module 621 extracts features from both the simulated robot 610 in OW 612 and the simulated robot body 650 in IW 652.

Feature extraction is the first step in the process that autonomous control system 630 uses to understand the OW 612. Autonomous control system 630 allows arbitrary addition and removal of feature extractor functions within the feature extraction module 621 which act on the raw simulated sensor data stream 611 and data from inner world sensors 653. Each feature extractor is a specialized submodule of the feature extraction module 621 that can be turned on or off. The specialized submodules may be turned on and off by an attention module.

Some feature extractors run all of the time and publish extraction results continuously, but most feature extractors run only when needed.

Examples of some of the feature extractors that are implemented in the feature extraction module 621 include:
The location, orientation and labels of all detected objects (inverse graphics)
Mapping of the environment (multi-resolution SLAM)
Text extracted from speech (speech to text)
Text extracted from OCR on visual feed (reading text)
Name labels extracted from recognizing specific people (facial recognition)
The presence or absence of a hand in the scene
Joint states for all actuators in the robot
Number of faces in the field of view

IW model 652 is generated using features which are extracted by feature extraction module 621.

Motion planning module 622 enables autonomous control system 630 to plan what motion the simulated robot 610 in the OW model 612 and the simulated robot body 650 in the IW model 652 will take.

The feature extraction module 621 extracts features from data generated by the inner world sensors 653 in IW model 652. As described above, this allows autonomous control system 630 to predict the effects of certain actions planned by motion planning module 622 within IW model 652 by simulated robot body 650 before enacting those actions within OW model 612 by simulated robot 610.

The concrete SRU module 633 receives feature extraction data from the feature extraction module 621 as well as data from the inner world sensors 653 and data from the IW scene graph 657 to generate a state representation of the IW model. The state representation represents a current understanding that the autonomous control system 630 has about the OW 612 and the position of the simulated robot 610 within the OW 612.

The state representation is data which semantically represents the current state of the OW (as characterized in the IW) in contrast to the IW itself which continuously varies and may be used to dynamically predict actions. That is, the state representation is a “snapshot” of the current state of the IW which the autonomous control system can use to “imagine” various actions or groups of actions that can be taken within the current state of the IW. The state representation may be used to logically reason and plan tasks and motions for the actuators with the IW model then being used to run simulations to predict the effects of the tasks and motions planned on the rest of the environment (including objects) using the state representation. Subsequent state representations are only captured by the concrete SRU module 633 when actions are being taken in the OW not when actions are being simulated within the IW, as nothing which is captured by the concrete SRU module 633 in a state representation (e.g., position of objects, orientation objects, position of robot, etc.) is altered during planning or simulation of actions. The state representation collects data streams from the inner world sensors 653, the IW scene graph 657, and feature extraction module 621 and turns the data into semantically meaningful data, e.g., “there is a cup on the bottom left corner of the table”. The scene graph includes the locations of any objects or people, the exact pose of the robot body, what task the robot is currently executing (e.g., the robot is executing a hand wave of the left hand). In a fully autonomous control situation, the objects and locations may be referred to by data points and coordinates, e.g., “move data point X to coordinates X,Y,Z”, while in a semi-autonomous control situation the objects and locations may be referred to with names, e.g., “move the apple to the middle of the tray”.

FIG. 7 is a block diagram showing an autonomous control system for a physical robot including a robot-perceived environment in accordance with the present systems, methods, and computer program products.

Physical robot 710 may be similar or identical to physical robot 610 of FIG. 6.

Physical robot 710 exists within a physical environment 712. Of note, there is no connection between a physical robot 710 operating in real-time and an OW model of simulated robot. However, physical robot 710 needs to be autonomously controllable in a manner similar (if not identical) to autonomous control of a simulated robot to ensure that the simulated robot is a good model for the physical robot. To that end, autonomous control of physical robot 710 includes generation of an IW model 752.

Physical robot 710 comprises a plurality of physical sensors 713 which generate data from physical environment 712 by sending sensor signals to a plurality of sensor drivers 714. The sensor drivers 714 send a raw sensor data stream 711 to autonomous control system 730.

Physical robot 710 comprises a plurality of physical actuators 715 which are controlled by a control software 716. The control software receives actuator data 721 from autonomous control system 730.

Autonomous control system 730 includes a feature extraction module 731, a motion planning submodule 732, and a concrete state representation updater (concrete SRU) 733. Autonomous control system 730 receives raw sensor data stream 711 from sensor drivers 714 and generates a “robot-perceived environment” or “inner world” (IW) model 752. IW model 752 is a robot-egocentric model of the physical environment 712 which includes a simulated robot body 750 comprising a model of the body of physical robot 710 as perceived by physical robot 710, inner world sensors 753, and inner world actuators 756. The inner world sensors 753 are simulated sensors which are analogous to the simulated sensor 713 and sensor drivers 714. The inner world actuators 756 are simulated actuators which are analogous to the control software 716 and the simulated actuators 715. The IW model 752 is generated by an IW scene graph 757, a rendering engine 758, and a physics engine 759.

The components of autonomous control system 730 are identical to the components of the autonomous control system 630 of FIG. 6. As described above, environmental information sent from a simulated robot cannot be distinguished from environmental information sent from a physical robot by the control system.

Because the raw data stream 711 only represents what the physical robot 710 has perceived about the physical environment 712, the information used to generate the IW model 752 is incomplete compared to the actual physical environment 712. There is more information within the physical 712 than the physical robot 710 can perceive. Not only is the information perceived by the physical robot 710 limited compared to the actual physical environment information available, but the information may actually be wrong. For example, a physical robot may perceive an apple as a ball. Generating the IW model 752 allows the autonomous control system 730 to imagine what the effects of action-taking would be inside of the IW model 752 before having to commit to actually taking those actions in the physical environment 712. This machinery allows autonomous control system 730 to ‘think about the world’, and predict what will happen in the future.

Autonomous control system 730 uses feature extraction module 721 to generate the IW model 752.

Feature extraction module 721 takes low-level, sub-symbolic, high bandwidth, complex sensory data streams, including raw video, audio, proprioceptive and haptic streams, and converts them into high-level, symbolic, semantically meaningful information called features. Feature extraction module 721 extracts features from both the physical robot 710 in physical environment 712 and the simulated robot body 750 in IW 752.

Feature extraction is the first step in the process that autonomous control system 730 uses to understand the physical environment 712. Autonomous control system 730 allows arbitrary addition and removal of feature extractor functions within the feature extraction module 721 which act on the raw sensor data stream 711 and data from inner world sensors 753. Each feature extractor is a specialized submodule of the feature extraction module 721 that can be turned on or off.

Some feature extractors run all of the time and publish extraction results continuously, but most feature extractors run only when needed.

IW model 752 is generated using features which are extracted by feature extraction module 721.

Motion planning module 722 enables autonomous control system 730 to plan what motion the physical robot 710 in the physical environment 712 and the simulated robot body 750 in the IW model 752 will take.

The feature extraction module 721 extracts features from data generated by the inner world sensors 753 in IW model 752. As described above, this allows autonomous control system 730 to predict the effects of certain actions planned by motion planning module 722 within IW model 752 by simulated robot body 750 before enacting those actions within physical environment 712 by physical robot 710.

The concrete SRU module 733 receives feature extraction data from the feature extraction module 731 as well as data from the inner world sensors 753 and data from the IW scene graph 757 to generate a state representation of the IW model.

Importantly, in FIG. 6 and FIG. 7, and in all embodiments of autonomous control, the data received by autonomous control systems 630 from simulated robot 610 and the data received by autonomous control system 730 from physical robot 710 is identical or approximately identical. The autonomous control systems 630 and 730 are identical. The autonomous control system 630/730 cannot identify from the data streams 611/711 whether the data is received from a simulated robot or a physical robot. IW model 652 and IW model 752 cannot be distinguished as perceived by a simulated robot or a physical robot. That is, in fully autonomous control an artificial intelligence controlling a robot may, by design, not know from the incoming data streams or from the IW model whether the robot sending the data stream is a simulated robot in an OW or a physical robot in a physical environment. As well, in semi-autonomous control a human operator controlling a robot could not know from the IW model, other data, or task options presented on a graphical user interface of the autonomous control system whether the robot sending the data stream is a simulated robot in an OW or a physical robot in a physical environment.

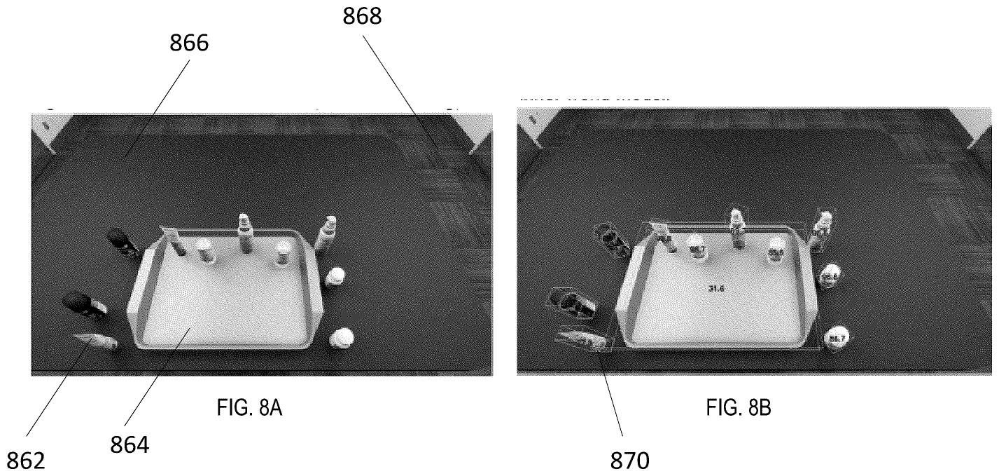

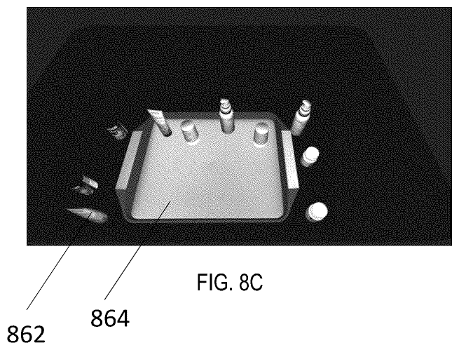

FIGS. 8A-C represent an outer world model, a feature extracted outer world model, and an inner world model, respectively. FIG. 8A shows a photo from a video feed of a simulated robot in a simulated environment, i.e., an OW. The simulated environment includes small items 862 (only one labelled to reduce clutter) on and around a tray 864 which is on a table 866 which is on a floor 868. FIG. 8B shows the same photo with feature extraction. Each object within the photo has the position and orientation of the object extracted as shown by the green rectangular prisms surrounding each object. Only small items 862 and tray 864 have been identified as objects. FIG. 8C shows an IW model representation of the outer world of FIGS. 8A and 8B as perceived by the simulated robot. FIG. 8C clearly shows the small items 862 and tray 864 which the robot has perceived within the outer world but lacks detail of the table or the floor which the objects are situated on. In this situation, feature extractors which extract the small items 862 and tray 864 have been turned on but not feature extractors which extract the table or floor. The robot may be able to perform tasks such as moving the smaller items 862 onto/off of the tray 864, but if tasked with moving the tray 864 onto the floor 868 feature extractors for those features would need to first be turned on.

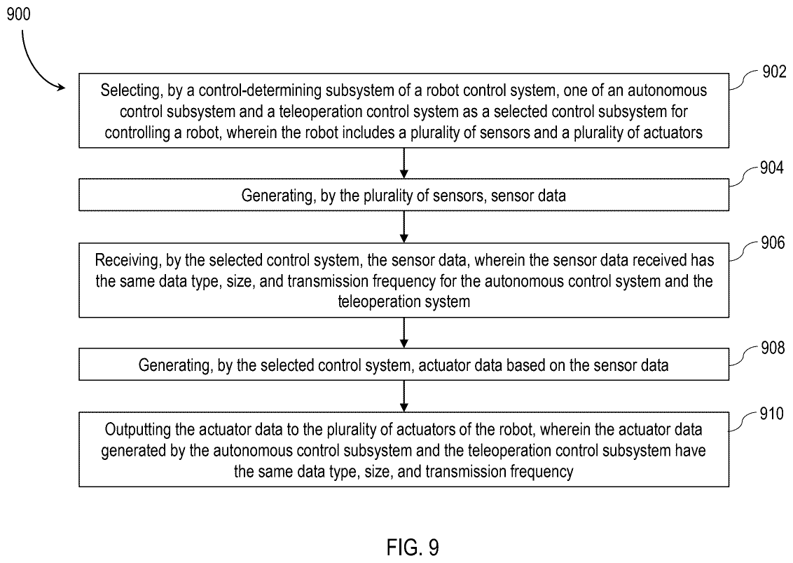

The IW model representation in FIG. 8C has been rendered by a rendering engine, such as rendering engine 658 of FIG. 6 or 758 of FIG. 7. In semi-autonomous control, a human operator views a rendered IW model representation like the image in FIG. 8C. However, it is to be understood that an image such as that shown in FIG. 8C may not be shown to an autonomous control system in such a form but may be communicated as other types of data. FIG. 9 is a flow diagram of a method for controlling a robot. The method may be performed by any of the systems described above in various embodiments. The control system includes a robot comprising a plurality of sensors and plurality of actuators. The control system also includes an autonomous control subsystem and a teleoperation control system which are both communicatively coupled to the robot, and a control-determining subsystem.

At 902, one of the autonomous control subsystem and the teleoperation subsystem is selected by the control-determining subsystem as the selected control subsystem to control the robot.

The robot may be interchangeable between a physical robot in a physical environment and a simulated robot in a simulated environment. The physical robot comprises a plurality of physical sensors generating physical sensor data and a plurality of physical actuators receiving physical actuator data. The physical robot comprises a plurality of simulated sensors generating simulated sensor data and a plurality of simulated actuators receiving simulated actuator data. Each simulated sensor is analogous to a respective physical sensor in a real world physical robot (that may or may not exist). The simulated sensor data is approximately the same as the respective physical sensor data. Each simulated actuators is analogous to a respective physical actuator in a real world physical robot (that may or may not exist). The simulated actuator data is approximately the same as the respective physical actuator data.

At 904, the plurality of sensors generate sensor data. The sensor data includes information about the environment of the robot as well as information about the robot itself. For example, the sensor data, both physical sensor data and simulated sensor data, may include at least one of audio sensor data, joint position data, pressure data, force sensitive resistor data, mobile base wheel encoder data, inertial measurement unit data, and visual data.

At 906, the selected control subsystem receives sensor data generated by the plurality of sensors. The sensor data has the same data type, the same size, and the same frequency of transmission from the robot to the selected control subsystem regardless of which of the autonomous control subsystem and teleoperation control subsystem is selected.

At 908, the selected control system generates actuator data based on the received sensor data. The actuator data, both physical actuator data and simulated actuator data, may include at least one of audio data, joint position data, impedance data, and mobile base motion data.

When the selected control subsystem is the autonomous control subsystem the control may be fully-autonomous or semi-autonomous. When the control is fully autonomous an artificial intelligence determines the autonomous actuator data. When the control is semi-autonomous a human operator determines the autonomous actuator data. In semi-autonomous control, a graphical user interface of the autonomous control subsystem is configured to display sensor data for viewing by the human operator, and an input device is configured to receive instructions from the human operator.

When the autonomous control subsystem is selected, a feature extraction module of the autonomous control subsystem may be configured to convert at least some of the sensor data to features, wherein features are semantically meaningful information. The features may include at least one of location of detected objects, orientation of detected objects, labels of detected objects, mapping of the environment, text extracted from speech, text extracted from visual feed, facial recognition labels, presence of hand in the scene, joint states for actuators of the robot, and faces in a field of view.

The feature extraction module may include a plurality of specialized submodules each configured to extract one feature from the sensor data. The autonomous control subsystem may include an attention module configured to turn the specialized submodule.

The autonomous control subsystem may be configured to continuously generate a robot-perceived model of the environment of the robot based on the features extracted from the robot sensor data by the feature extraction module, wherein the data type, data size, and data frequency of the sensor data and the actuator data are the same for a physical environment, a simulated environment, and the robot-egocentric model.

The autonomous control subsystem may be configured to test actuator data within the robot-egocentric model to determine the effects of an actuator data driven action before sending the actuator data to the robot.

The autonomous control subsystem may include a concrete state representation updater configured to provide data about the current state of the remote environment as understood by the autonomous control subsystem.

When the selected control subsystem is the teleoperation control subsystem, the teleoperation subsystem may perform “low-level operation” wherein the control subsystem includes hardware for transmitting sensor data from the robot to a human operation as sensory information and hardware for tracking motion of the human operator, e.g., a “pilot rig”. The pilot rig may include haptic gloves, an exoskeleton configured to use encoder measurements and forward kinematics to determine a position and an orientation of the limbs of the human operator, wherein the exoskeleton includes motors within the joints to provide force feedback to the human operator, a headset for providing visual and auditory information about the robot and the remote environment to the human operator, and bidirectional pedals to control a mobile base of the robot.

At 910, the selected control subsystem outputs the actuator data to the plurality of actuators of the robot to cause the robot to perform actions. The actuator data has the same data type, same size, and the same frequency of transmission from the selected control subsystem to the robot regardless of which of the autonomous control subsystem and teleoperation control subsystem is selected.

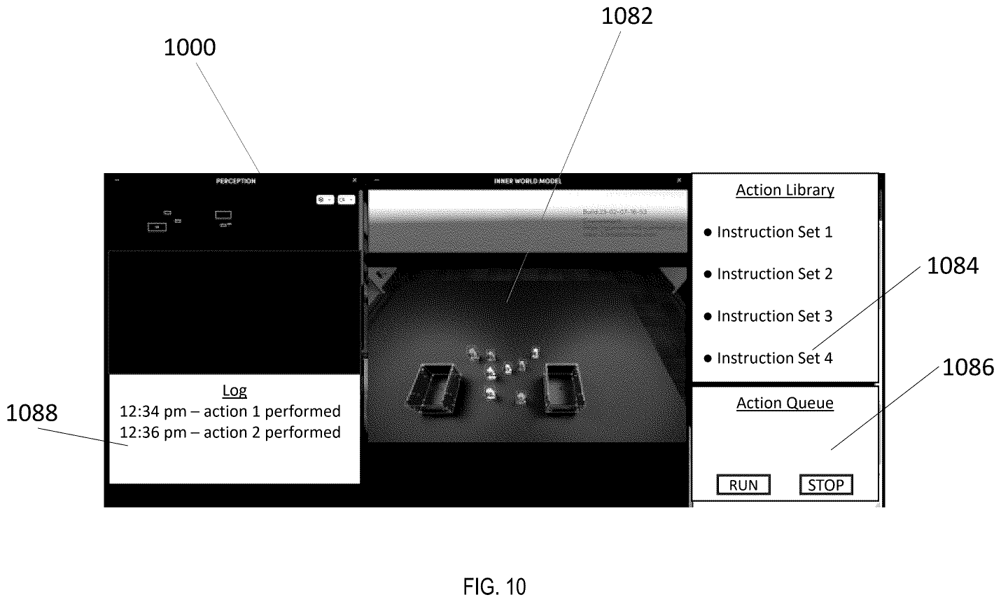

FIG. 10 is a representation of a graphical user interface (GUI) 1000 shown to a human operator for semi-autonomous control. The GUI 1000 is presented to the human operator on a screen, for example, a laptop screen, or a tablet screen.

GUI 1000 includes a visualization of an inner world model 1082. In IW model 1082 there are ten detected objects, including eight small items and two receptacles all sitting on the same surface. The green lines around the small items and receptacles represent feature extraction of objects. From the IW model 1082 the human operator knows that the robot is perceiving these ten objects and knows the orientations and positions of the objects within the environment. The GUI only shows human operator information which is created from the perception of the robot. The human operator does not access any direct feeds from the outer world, e.g., camera views from the perspective of the robot or from a perspective within the environment that is not the robot's.

The GUI 1000 includes a list of actions (i.e., “instructions” or “work primitives”), in an action library 1084, which can be performed by the robot. The actions displayed in action library 1084 are from an instruction set identical to an instruction set that would be used by the cognitive architecture control system in fully autonomous control. The human operator selects at least one object from the IW model 1082 shown in the GUI 1000 and is shown within the action library 1084 the possible actions that can be taken with the object. The human operator may select objects by any appropriate input means, for example, a mouse, a keyboard, a touchscreen, etc. The human operator may select a detected object to receive an instruction set which lists only those actions which can be taken with the selected detected object. The instruction set may comprise a drop-down menu of the possible actions. Each of the detected objects may have a drop-down menu which lists the possible actions which can be taken with the respective detected object. The human operator may be shown all possible actions which can be taken for the ten detected objects. The possible actions may be informed by the context of the OW environment and the detected objects as perceived by the robot.

The GUI 1000 includes an action queue 1086 which is a list of the next actions which are to occur. That is, the human operator can pick several actions and an order for those actions to be taken and add those to a plan to be followed. The action queue 1086 includes a RUN button and a STOP button which the human operator can use to start and stop the actions of the robot.

The GUI 1000 includes a log 1088 which keeps a record of the actions that have already been taken by the robot.

The robots described herein may, in some implementations, employ any of the teachings of U.S. patent application Ser. No. 16/940,566 (Publication No. US 2021-0031383 A1), U.S. patent application Ser. No. 17/023,929 (Publication No. US 2021-0090201 A1), U.S. patent application Ser. No. 17/061,187 (Publication No. US 2021-0122035 A1), U.S. patent application Ser. No. 17/098,716 (Publication No. US 2021-0146553 A1), U.S. patent application Ser. No. 17/111,789 (Publication No. US 2021-0170607 A1), U.S. patent application Ser. No. 17/158,244 (Publication No. US 2021-0234997 A1), U.S. Provisional Patent Application Ser. No. 63/001,755 (Publication No. US 2021-0307170 A1), and/or U.S. Provisional Patent Application Ser. No. 63/057,461, as well as U.S. Provisional Patent Application Ser. No. 63/151,044, U.S. Provisional Patent Application Ser. No. 63/173,670, U.S. Provisional Patent Application Ser. No. 63/184,268, U.S. Provisional Patent Application Ser. No. 63/213,385, U.S. Provisional Patent Application Ser. No. 63/232,694, U.S. Provisional Patent Application Ser. No. 63/253,591, U.S. Provisional Patent Application Ser. No. 63/293,968, U.S. Provisional Patent Application Ser. No. 63/293,973, U.S. Provisional Patent Application Ser. No. 63/278,817, and/or U.S. patent application Ser. No. 17/566,589, each of which is incorporated herein by reference in its entirety.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A method of controlling a robot, the method comprising:
selecting, by a control-determining subsystem, which one of an autonomous control subsystem and a teleoperation control subsystem controls the robot, wherein the robot comprises a plurality of sensors configured to convert information from an environment and the robot into sensor data, wherein each sensor of the plurality of sensors generates a stream of raw sensor data having a data type, a size, and a frequency, and a plurality of actuators configured to cause movement of the robot;
when the autonomous control subsystem is selected:
receiving, by the autonomous control subsystem, the sensor data from the plurality of sensors;
generating, by the autonomous control subsystem, autonomous actuator data based on the sensor data; and
outputting autonomous actuator data to the plurality of actuators of the robot; and
when the teleoperation control subsystem is selected:
receiving, by the teleoperation control subsystem, the sensor data from plurality of sensors;
transmitting, by the teleoperation control subsystem, the sensor data to a human operator, and
generating, by the teleoperation control subsystem, teleoperation actuator data based on the sensor data; and
outputting, by the teleoperation control subsystem teleoperation actuator control signals to the plurality of actuators, wherein the teleoperation actuator data are generated according to input from the human operator; and
wherein the autonomous control subsystem and the teleoperation control subsystem receive, from the robot, sensor data having the same data type, the same size, and the same frequency for each of the plurality of sensors; and
wherein the autonomous actuator data and the teleoperation actuator data have the same data type, the same size, and the same frequency for each of the plurality of actuators.

2. The method of claim 1 wherein the robot is interchangeable between a physical robot in a physical environment and a simulated robot in a simulated environment wherein:
the plurality of sensors of the physical robot comprise a plurality of physical sensors generating physical sensor data from the physical environment, and the plurality of actuators of the physical robot comprises a plurality of physical actuators receiving physical actuator data;
the plurality of sensors of the simulated robot comprises a plurality of simulated sensors generating simulated sensor data from the simulated environment, and the plurality of actuators of the simulated robot comprises a plurality of simulated actuators receiving simulated actuator data; wherein:
each simulated sensor is analogous to a respective physical sensor wherein the simulated sensor data is approximately the same as the respective physical sensor data; and
each simulated actuator is analogous to a respective physical actuator wherein the simulated actuator data is approximately the same as the respective physical actuator data.

3. The method of claim 1 wherein the autonomous control subsystem controls the robot with fully autonomous control, wherein artificial intelligence determines the autonomous actuator data.

4. The method of claim 1 wherein the autonomous control subsystem controls the robot with semi-autonomous control, wherein a human operator determines the autonomous actuator data.

5. The method of claim 4 wherein the autonomous control subsystem includes a graphical user interface and an input device, and the method further comprises:
displaying the sensor data on the graphical user interface for viewing by the human operator; and
receiving instructions through the input device from the human operator.

6. The method of claim 1 wherein the autonomous control subsystem includes a feature extraction module and the method further comprises:
receiving at least one sensor data stream of the sensor data from the robot by the feature extraction module; and
converting the at least one sensor data stream to features, wherein features are semantically meaningful information.

7. The method of claim 6 wherein the features includes at least one of: location of detected objects, orientation of detected objects, labels of detected objects, mapping of the environment, text extracted from speech, text extracted from visual feed, facial recognition labels, presence of hand in the scene, joint states for actuators of the robot, and faces in a field of view.

8. The method of claim 6 wherein the feature extraction module comprises a plurality of specialized submodules and the method further comprises:
extracting a feature from the at least one sensor data stream by at least one specialized submodule.

9. The method of claim 8 further comprising wherein the autonomous control subsystem further comprises an attention module and the method further comprises:
setting an on or off status at least one of the specialized submodules by the attention module.

10. The method of claim 6 further comprising generating, by the autonomous control subsystem, a robot-perceived model of the environment of the robot based on the features extracted from the robot sensor data by the feature extraction module, wherein the data type, data size, and data frequency of the sensor data and the actuator data are the same for a physical environment, a simulated environment, and the robot-egocentric model.

11. The method of claim 10 further comprising testing, by the autonomous control subsystem, actuator data within the robot-egocentric model to determine the effects of an actuator data driven action before sending the actuator data to the robot.

12. The method of claim 10 wherein the autonomous control subsystem includes a concrete state representation updater and the method further comprises providing data about the current state of the remote environment, as understood by the autonomous control subsystem, by the concrete state representation updater.

13. The method of claim 1 wherein the teleoperation system is a low-level teleoperation (LLT) system including hardware for transmitting sensor data from the robot to the human operator as sensory information and hardware for tracking the motion of the human operator.

14. The method of claim 1 wherein the sensor data includes at least one of audio sensor data, joint position data, pressure data, force sensitive resistor data, mobile base wheel encoder data, inertial measurement unit data, and visual data.

15. The method of claim 1 wherein the actuator data includes at least one of audio data, joint position data, impedance data, and mobile base motion data.

16. A control system for interchangeably controlling operation of a physical robot and a simulated robot analogous to the physical robot, the system comprising:
the physical robot, including:
a plurality of sensors configured to convert information from a physical environment and information from the physical robot into physical sensor data, wherein each sensor of the plurality of sensors generates a stream of raw sensor data having a data type, a size, and a frequency;
a plurality of physical actuators configured to cause movement of the physical robot;
the simulated robot, including:
a plurality of simulated sensors configured to convert information from a simulated environment and information from the simulated robot into sensor data; and
a plurality of simulated actuators configured to cause movement of the simulated robot;
wherein:
each simulated sensor is analogous to a respective physical sensor wherein the simulated sensor data is approximately the same as the respective physical sensor data;
each simulated actuator is analogous to a respective physical actuator wherein the simulated actuator data is approximately the same as the respective physical actuator data;
the physical sensor data and the simulated sensor data have the same data type, the same size, and the same frequency; and
a control subsystem, communicatively coupled to the physical robot and the simulated robot, and configured to receive the physical sensor data from the plurality of physical sensors and output actuator data to the plurality of physical actuators, and configured to receive the simulated sensor data from the plurality of simulated sensors and output simulated actuator data to the plurality of simulated actuators, wherein the physical actuator data and the simulated actuator data have a same data type, a same size, and a same frequency.

17. The control system of claim 16 wherein the control subsystem is an autonomous control subsystem.

18. The control system of claim 16 wherein the control subsystem is a teleoperation control subsystem.
